(19) United States
(12) Patent Application Publication
(10) Pub. No.: US 2015/0321163 A1
(43) Pub. Date: Nov. 12, 2015

(54) METHOD FOR MAINTAINING HETEROGENEOUS CONCENTRATIONS OF MOLECULES IN EMULSION DROPLETS

(71) Applicant: GnuBio, Inc., Cambridge, MA (US)

(72) Inventors: Tony Hung, Cambridge, MA (US); Joshua Blouwolf, Brookline, MA (US); Sepehr Kiani, Cambridge, MA (US)

(73) Assignee: GnuBio, Inc., Cambridge, MA (US)

(21) Appl. No.: 14/652,094

(22) PCT Filed: Dec. 16, 2013
(86) PCT No.: PCT/US13/75461

§ 371 Date: Jun. 12, 2015

Related U.S. Application Data
(60) Provisional application No. 61/737,625, filed on Dec. 14, 2012.

(51) Int. Cl. B01J 19/00

(52) U.S. Cl. CPC B01J 19/0046; B01J 2219/00722; B01J 2219/00599

(57) ABSTRACT

The present invention provides a method for maintaining heterogeneous concentrations of transitory target molecules in emulsion droplets by using one of a number of means to associate them to other, non-transitory molecules within the emulsion droplets contained in a microfluidic device. The present invention further provides a method for ensuring that the concentration and speciation of molecules will remain constant when stored in emulsion droplets. This results in emulsion droplets having heterogeneous concentrations of molecules, thereby improving the performance and applicability of droplet-based microfluidics.

### RELATED APPLICATIONS AND INCORPORATION BY REFERENCE

This application claims priority to U.S. provisional patent application Ser. No. 61/737,625 filed Dec. 14, 2012.

The foregoing application, and all documents cited therein or during its prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention is in the technical field of microfluidics. More particularly, the present invention relates to a method for maintaining molecules in droplets within an emulsion.

### BACKGROUND OF THE INVENTION

Microfluidic processes often employ the use of an emulsion, which contains droplets (herein referred to as “emulsion droplets”) of a dispersed liquid phase surrounded by an immiscible continuous liquid phase. Emulsion droplets may be used as reaction vessels for chemical or biological reactions, as storage vessels, and/or as a method to isolate and compartmentalize molecules, such as chemical or biological elements. A population of emulsion droplets (herein referred to interchangeably as a “population” or “library”) may be composed of droplets of many different sizes (polydispersed population) or droplets of relatively same size (monodispersed population). With proper chemistry such as surfactants on the surface of the emulsion, droplets may be made “stable,” meaning they are substantially prevented from mixing and merging when in contact with each other. This stability allows one to create a population or library of droplets composed of different chemical or biological components that may be stored in the approximately same volume of space without mixing or contamination between and/or among the components of one droplet and another (herein referred to as “speciation”). This term will be used herein in reference to discussing different chemical molecules within the same emulsion droplet). This property of stabilized emulsion droplets is useful for many applications in performing chemical and biological reactions, storage and compartmentalization.

One problem is that while some relatively large entities, such as some cells and proteins, may be encapsulated by droplets and stored stably (e.g., the droplets maintain their initial composition and concentration) over days, weeks, months and/or longer without the molecules leaking or being exchanged between adjacent droplets in a population, some molecules and/or molecules are able to transit the emulsion droplet boundary (herein referred to as an “interface”) and will transfer and mix between and/or among droplets. Such molecules tend to be smaller than non-transitory entities. Some examples of such transit-prone molecules include but are not limited to: chemical dyes, fluorescent molecules, luminescent molecules, vitamins, pharmaceutical precursors, small molecule pharmaceutical molecules, quantum dots, antigens, sugars, nucleosides, and nucleotides.

For example, a population of droplets emulsified with a given concentration of molecule A may be brought into proximity via a shared continuous phase with a population of droplets emulsified with a given concentration of molecule B, thereby creating an emulsion containing a mix of two distinct populations of droplets. If molecules A and B are able to transit across the interface and be transported between droplets, then the concentrations of molecules A and B in the emulsion droplets will tend to equilibrate leading to a homogeneous collection of droplets with the same concentrations of molecules A and B within the droplets (See FIG. 1).

However, there are certain applications, such as but not limited to, creating and storing a population or library of droplets composed of substantially distinct fluorescent dye compositions and concentrations, that require that the emulsion contain a stable population of droplets with heterogeneous concentrations of distinct fluorescent molecules. Accordingly, there is a need for a method for preventing the equilibration in concentration of molecules that will transit across the interface, as is provided by the following invention.

The present invention provides a method for maintaining the preferred concentration and speciation of molecules within emulsion droplets, which without would result in the transit of molecules into and/or out of droplets. This results in an emulsion with heterogeneous small molecule concentrations, thereby improving the performance and applicability of droplet-based microfluidics. Accordingly, the present invention provides a method for maintaining heterogeneous concentrations of molecules within droplets present in an emulsion (“emulsion droplets”).

Citation or identification of any document in this application is not an admission that such document is available as prior art to the present invention.

### SUMMARY OF THE INVENTION

The present invention generally provides a method for maintaining the preferred speciation and associated concentration of molecules within emulsion droplets. More specifically, the present invention provides a method for maintaining heterogeneous concentrations of molecules within droplets present in an emulsion (“emulsion droplets”) by substantially preventing transit of molecules across the emulsion droplet boundary (“interface”). The present invention generally pertains to a method for maintaining both the molecular composition and concentration of molecules within emulsion droplets, notably molecules that can easily transit across the interface which tend to be smaller in size than molecules that do not transit across the emulsion droplet boundary (“interface”).

One embodiment of the present invention further comprises a method for associating a non-transitory molecule to a target molecule within the emulsion droplet, thereby preventing the targeted molecule from transporting across the interface. In one aspect, the means of associating (or attaching) a non-transitory molecule to a target molecule, may be achieved by a number of means, including but not limited to: chemical binding or conjugation; other forms of chemical bonds, including but not limited to, covalent and hydrogen bonds; biologically mediated attachments such as antibody-antigen binding; and/or DNA binding by Watson-Crick base pairing. In another aspect, other forms of attachment or association may be employed, including but not limited to, encapsulating or enveloping a molecule that is capable of transit across the interface with a larger molecule that will not transit across the interface. One example of this aspect includes embedding the target molecule in a larger polymer shell enclosed within a protein complex. In yet another aspect, one or more molecules may be maintained within a droplet and substantially prevented from transiting the interface by binding with other molecules with preferred solubility in the dispersed phase or, alternatively, with very low affinity for the dispersed phase side of surfactants.

Another embodiment of the present invention comprises substantially maintaining the heterogeneity of initial concentrations of a single molecule and/or multiple molecules within a population of emulsion droplets relatively constant over time. In one aspect of this embodiment, the desired concentrations and/or distribution of different chemical molecule may differ between individual emulsion droplets, wherein the emulsion droplets comprise the population of a given emulsion.

Another embodiment of the present invention comprises substantially maintaining the heterogeneous distribution of concentrations of molecules in a population of emulsion droplets substantially constant over time such as to minimize a tendency toward an equilibrium state of a homogeneous concentration distribution.

Another embodiment of the present invention comprises substantially maintaining the heterogeneous distribution of distinct chemical molecule in a population of emulsion droplets such that the distribution remains substantially constant over time such as to minimize a tendency toward an equilibrium state of a homogeneous distribution of distinct chemical molecules.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1A illustrates that a population of emulsion droplets containing a heterogeneous concentration distribution of two distinct chemical species A and B molecules tends to equilibrate over time to a population with a homogeneous concentration distribution of a mixture of molecule A and molecule B within droplets, without other molecules attached.

FIG. 1B illustrates that a population of emulsion droplets containing a heterogeneous concentration distribution of two distinct chemical species A and B (the initial population as described in FIG. 1A) chemically bound to other molecules (x) maintain those heterogeneous concentrations over time. This is illustrated by the bar graphs below the droplet illustrations, demonstrating that over time there are substantially no droplets that contain a mixture of molecule A and molecule B due to the addition of the x molecule to A and B.

FIG. 2 is a graphical illustration of the fluorescent intensity histogram placed in the same space as the illustrated droplets. FIG. 2 illustrates an embodiment of the present invention wherein emulsion droplets (101-104) contain four different concentrations of a given molecule A which, by means as described herein, has been attached to a non-transitory molecule (x, which in this example, is a fluorescent molecule).

FIG. 3A illustrates an embodiment of the present invention wherein two separate droplets, which may be found within a population of emulsion droplets, contain different molecular species (A and B) and different concentrations of species A and B. Over time, the molecules within the droplets tend to transit the interface between molecules resulting in a homogenous concentration distribution and a homogeneous distribution of chemical species within the population of emulsion droplets.

FIG. 3B illustrates a similar embodiment as the one in FIG. 3A, but wherein a non-transitory molecule (x) has been attached to the transitory molecules A and B. In this example, as time lapses, the heterogeneous distributions of concentrations and of molecular species remain substantially stable over time.

### DETAILED DESCRIPTION OF THE INVENTION

The present invention generally pertains to a method for maintaining heterogeneous concentrations of transitory target molecules in emulsion droplets by using one of a number of means to bind them to other, non-transitory molecules within droplets contained in a microfluidic device.

In an embodiment of the invention, the emulsion droplets are present in a microfluidic device. A “microfluidic device”, as used herein, is a device that enables a means of effecting a deterministic function on liquid or gas fluids at small scales typically measured in volumes such as, for example, milliliter (mL), microliter (μL), nanoliter (nL), picoliter (pL), or femtoliter (fL) volumes and/or by physical scale such as millimeter (mm), micrometer (μm) (also referred to as “micron”), nanometer (nm), or picometer (pm). Functions may include mixing, splitting, sorting, heating, and so forth. Microfluidic devices may comprise microfluidic channels as a means for transferring fluids or samples from one point to another and are typically of uniform cross section in the mm, μm or nm scale. The emulsion droplets may be moved through a microfluidics device, stored in the microfluidic device or placed within a geometry in the microfluidic device where more than one droplet is present.

A wide variety of methods and materials exists and will be known and appreciated by one of skill in the art for construction of microfluidic channels and networks thereof, such as those described, for example, in U.S. Pat. No. 8,047,829, which is incorporated herein by reference in its entirety. For example, the microfluidic channel may be constructed using simple tubing, but may further involve sealing the surface of one slab comprising open channels to a second flat slab. Materials into which microfluidic channels may be formed include silicon, glass, silicones such as polydimethylsiloxane (PDMS), and plastics such as poly(methyl-methacrylate) (known as PMMA or “acrylic”), cyclic olefin polymer (COP), and cyclic olefin copolymer (COC). The same materials can also be used for the second sealing slab. Compatible combinations of materials for the two slabs depend on the method employed to seal them together. The microfluidic channel may be encased as necessary in an optically clear material to allow for optical excitation (resulting in, e.g., fluorescence) or illumination (resulting in, e.g., selective absorption) of a sample as necessary, and to allow for optical detection of spectroscopic properties of light from a sample, as the sample is flowing through the microfluidic channel. Preferred examples of such optically clear materials that exhibit high optical clarity and low autofluorescence include, but are not limited to, borosilicate glass (e.g., SCHOTT BOROFLOAT® glass (Schott North America, Elmsford N.Y.)) and cyclo-olefin polymers (COP) (e.g., ZEONOR® (Zeon Chemicals LP, Louisville Ky.)).

A “droplet”, as used herein, means an isolated aqueous or lipophilic phase within a continuous phase having any shape, for example but not limited to, cylindrical, spherical and ellipsoidal, as well as flattened, stretched or irregular shapes and so on. One or more droplets according to the present invention may be used to perform various functions, including but not limited to, serving as reaction vessels for performing chemical reactions; collectively encompassing a library of elements, including but not limited to a library of oligonucleotide probes; or as lenses for focusing a laser for optical applications. In one embodiment of the invention, one or more droplets are contained within an emulsion. In another embodiment of the invention, one or more droplets are contained within an emulsion in a microfluidic device. A droplet may further comprise a “sample” or “sample to be tested,” both of which may be used interchangeably.

Dyes may be incorporated into a droplet, either at the time of droplet formation or after droplet formation using any injection method known and appreciated by one of skill in the art. Dyes may be incorporated during droplet formation by flowing or streaming the desired dye composition as a fluid stream into a droplet-maker design. Droplet-making designs and methods include but are not limited to those described in International Patent Publications WO 2004/002627 and WO 2006/096571, each of which is incorporated herein in its entirety.

In one embodiment of the method of the present invention, it is preferred that an emulsion droplet with more than one type of molecule within its bounds maintain its original composition of molecules. “Speciation,” as used herein, refers to the specific chemical makeup of the droplet in reference to the molecules the droplet contains. It is desirable to maintain the integrity of the molecular composition for data analysis purposes. In one example, an emulsion droplet contains molecule A and molecule B. The speciation of this emulsion droplet is different from another emulsion droplet which contains molecule A and molecule C.

An “emulsion”, as used herein, is a stable mixture of at least two immiscible or partially immiscible liquids. In general, immiscible liquids tend to separate into two distinct phases. Accordingly, a surfactant may be added to stabilize the emulsion by reducing surface tension between the at least two immiscible or partially immiscible liquids and/or to stabilize the interface. For example, an emulsion may comprise a plurality of aqueous droplets in an immiscible oil, such as fluorocarbon oil, silicon oil or hydrocarbon oil (including but not limited to, petroleum and mineral oil) where the droplet size ranges from about 0.5 to about 5000 microns in diameter.

An “emulsion droplet” as used herein, refers to a droplet within a particular emulsion, which contains a preferred stable concentration of molecules and or a preferred speciation of molecules. As used herein, it is suggested that “emulsion droplet” and “droplet” be used interchangeably as this invention pertains to droplets within an emulsion.

An “interface”, as used herein when referring to the interface between a droplet and a fluid and/or emulsion, is one or more region where two immiscible or partially immiscible phases (e.g., a droplet and a fluid or emulsion) are capable of interacting with each other.

The term “transitory molecule” as used herein is used to refer to a molecule or molecule that contains properties that allows it to transit across emulsion droplet boundaries and tend to be smaller in size than molecules that do not transit across emulsion droplet boundaries. A number of factors may affect molecular transit across droplet boundaries such as size, surface charge, solubility and polarity may significantly affect a molecule's ability to transit across a droplet boundary. All these properties can be used in the scope of this invention. As used herein, transitory molecules are generally referred to as the molecules within droplets that are desired to maintain their concentration and speciation within droplets.

Classes of transitory molecules include but are not limited to: fluorescent molecules, luminescent molecules, short nucleic acids, vitamins, pharmaceuticals, and pharmaceutical precursors.

In one embodiment of the present invention, the system provides for the detection and measurement of wavelength and intensity of fluorescence emitted by one or more samples following excitation, wherein fluorescently-labeled samples are identified by combinations of different colors and intensities of fluorescent material. The fluorescent material is referred to as a “fluorescent label” or “fluorophore” or “fluorescent dye”, each of which as used herein when describing a “fluorescently-labeled sample” may be a fluorescent molecule, a fluorescent semiconductor nanoparticle (referred to as a “quantum dot”), or a chelated lanthanide or lanthanoid, having the ability to absorb energy from light of a specific wavelength, and then emit this energy as fluorescence in another specific wavelength characteristic for the particular molecule or quantum dot. In this manner, the fluorophore will facilitate the final assay readout indicating the presence or absence of a particular target of interest in the sample. In one aspect of this embodiment, a fluorescently-labeled sample is present within a droplet. In another aspect, a fluorescently-labeled sample is present within or coated on a discrete particle. In one example, the discrete particle is a cell. In another example, the discrete particle is a bead. In another aspect, a fluorescently-labeled sample is present within a single-phase flow.

In another embodiment of the invention, the use of a library or population of emulsion droplets containing fluorescent dye is used as a liquid label barcode to help identify the composition and identity of each emulsion droplet. This may be useful for droplet and microfluidic droplet applications such as performing a DNA/RNA reaction inside each droplet composed of a library of small oligonucleotide probes, DNA sequencing and genotyping reactions, and PCR based reactions. Another application is for protein crystallization studies and studying the formation of protein structures over time. Another application is in cell reaction studies where cells within droplets are exposed to different antigens to look for the production of antibodies. Another application is in cell reaction studies where the cells encapsulated in droplets will excrete enzymes that may be assayed for activity by looking at modification to a substrate resulting in the emission of fluorescence of a fluorogenic molecule.

The particular fluorophore employed is not critical to the present invention. Fluorophores are known in the art and are described, for example, by Marras, “Selection of Fluorophore and Quencher Pairs for Fluorescent Nucleic Acid Hybridization Probes”, In: V. Didenko, ed. 2006. Fluorescent Energy Transfer Nucleic Acid Probes: Designs and Protocols (Methods in Molecular Biology, vol. 335). New Jersey: Humana Press Inc., pp. 3-16. Examples of fluorophores that may be employed in the present invention include, but are not limited to, those described by Marras 2006 and further described herein below. One of skill in the art will appreciate the various fluorescent dyes that may serve as fluorescent labels and that may be employed in the present invention and which are available from various commercial vendors.

Examples of fluorescent dyes that may be employed in the present invention include, but are not limited to, the following: fluorescein and derivatives thereof (e.g., fluorescein isothianate (FITC), carboxyfluorescein (FAM), tetrachlorofluorescein (TET), 2′,7′-difluorofluorescein (Oregon Green® 488), Oregon Green® 514 carboxylic acid, and a fluorescein with chloro and methoxy substituents (JOE and 6-JOE)); rhodamine derivatives (e.g., tetramethyl rhodamine (TAMRA), tetramethyl rhodamine iso-thiocyanate (TRITC), tetramethylrhodamine (TMR), carboxy-X-rhodamine (ROX), Texas Red (a mixture of isomeric sulfonyl chlorides and sulforhodamine; Invitrogen™) and Texas Red-X (Texas Red succinimidyl ester, which contains an additional seven-atom aminohexanoyl spacer (“X”) between the fluorophore and its reactive group; Invitrogen™), and Rhodamine X); cyanine (Cy) dyes (e.g., Cy3, Cy5 and Cy5.5) and cyanine derivatives (e.g., indocarbocyanine (Quasar® 570, Quasar® 670 and Quasar® 705), Oregon Green® isothiocyanate, and eosin isothiocyanate (EITC)); N-hydroxysuccinimidyl 1-pyrenebutyrate (PYB); N-hydroxysuccinimidyl 1-pyrenesulfonate (PYS); (5-(2′-aminoethyl)aminonaphthalene (EDANS); CAL Fluor® Gold 540, CAL Fluor® Orange 560, Fluor® Red 590, CAL Fluor® Red 610, and CAL Fluor® Red 635 (proprietary fluorophores available from Biosearch Technologies, Inc.); VIGO; HEX® (a 6-isomer phosphoramidite); and NED®.

The particular quantum dot (QD) employed is not critical to the present invention. Quantum dots are known in the art and are described, for example, by Han et al., “Quantum-dot-tagged Microbeads for Multiplexed Optical Coding of Biomolecules”, Nat Biotechnol (July 2001) vol. 19, pp. 631-635. One of skill in the art will appreciate the various quantum dots that may serve as fluorescent labels and that can be employed in the present invention and which are available from various commercial vendors. Examples of quantum dots (QDs) that may be employed in the present invention include, but are not limited to, the following: cadmium selenide (CdSe) quantum dot nanoparticles (e.g., CdSe Quantum Dot Cores, 480-640 nm emission spectra, Sigma-Aldrich®); cadmium sulfide (CdS) quantum dot nanoparticles (e.g., CdS Quantum Dot Cores, 380-480 nm emission spectra, Sigma-Aldrich®); zinc sulfide-capped cadmium selenide (ZnS-capped CdSe) nanocrystals (e.g., CdSe/ZnS Lumidots™ and CdSe/ZnS NanoDots™, 480-640 nm emission spectra, Sigma-Aldrich®); and cadmium-free quantum dots (e.g., CFQD™, 400-650 nm emission spectra, Sigma-Aldrich®).

The particular chelated lanthanide or lanthanoid employed is not critical to the present invention. Lanthanides and lanthanoids are known in the art to comprise the fifteen metallic chemical elements with atomic numbers 57 through 71, from lanthanum (La) through lutetium (Lu). Examples of lanthanides or lanthanoids in chelated form that may be employed in the present invention include, but are not limited to, the following: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

According to the method of the present invention, the sample to be tested may be analyzed for spectroscopic intensity measurements of each spectroscopic substance, wherein the spectroscopic intensity measurement of the reference spectroscopic substance may be used to correct the spectroscopic intensity measurement of one or more sample spectroscopic substances. Depending on the application, the spectroscopic properties may comprise: light scattered from a sample to be tested following illumination of the sample to be tested; light emitted as chemiluminescence by a chemical process within the sample to be tested; light selectively absorbed by a sample to be tested following direction of a broadband light source at the sample to be tested; or light emitted as fluorescence from a sample to be tested following excitation of the sample to be tested.

The spectroscopic intensity and wavelength of a spectroscopic substance may be measured by any methods for spectroscopic analysis known and appreciated by one of ordinary skill in the art. Spectroscopic methods that may be utilized in the present invention include, but are not limited to, a laser and photodetector pair system or more complex optics known to those of skill in the art where the path of an optical beam intersects with the path of a spectroscopic substance and the excitation or illumination of the spectroscopic substance is captured by an optical path comprising one or more objective, mirror, and/or lens to direct the light to a photomultiplier tube (PMT) or photosensitive camera. A known fluoroscopy method that will be known and appreciated by one of skill in the art for use in the present invention is the use of flow cytometry instrumentation.

The reference spectroscopic substance should be chosen so as to have a signal that is distinguishable from the one or more sample spectroscopic substances. While the reference spectroscopic substance and the one or more sample spectroscopic substances may each comprise the same type of spectroscopic substance, it is impractical to select a reference spectroscopic substance that exactly matches the one or more sample spectroscopic substances in composition, as one cannot separate out the signal between two identical spectroscopic substances. The reference spectroscopic substance should inhabit substantially the same environmental conditions as those of one or more sample spectroscopic substances when spectroscopic intensity is measured. When practical, it is preferable that the reference spectroscopic substance be excited or illuminated by the same light source as the one or more sample spectroscopic substances, such that the reference spectroscopic substance can capture fluctuations in the power of the excitation or illumination light that may contribute to “noise” in the signal.

For example, if the reference spectroscopic substance is excited or illuminated by light source X and at least one of the one or more sample spectroscopic substances is excited or illuminated by light source Y, then variations in the reference spectroscopic substance may be attributed to light source X and may have no bearing on the variations due to light source Y. A combination of different quantities and types of spectroscopic substances allows one to assign a unique value to and a more accurate determination of the spectroscopic intensity measured in each sample to be tested.

The spectroscopic intensity measurements may comprise one or more methods, including but not limited to, light scatter, absorption, chemiluminescence, fluorescent intensity, radiation decay counts, colorimetric, and so forth. Samples to be tested are placed in the path of an excitation energy source such as a light source selected from but is not limited to, lasers, light-emitting diodes (LEDs), arc lamps, broadband light source, and high intensity light bulbs. The spectroscopic substances in the sample to be tested scatter, absorb, chemiluminesce, or fluoresce (also referred to herein as “signal”) in the form of light at a wavelength substantially different from the wavelength of the light source. This light from the sample to be tested is then captured by a detector or sensor, which may be selected from but is not limited to, a camera, a charge coupled device (CCD), a complementary metal-oxide-semiconductor (CMOS) (alternatively referred to as a complementary-symmetry metal-oxide-semiconductor (COS-MOS)), one or more individual photodiodes, photodiode arrays (PDAs), avalanche photodiodes (APDs), avalanche photodiodes arrays, photomultiplier tubes (PMTs), or photomultiplier tube arrays.

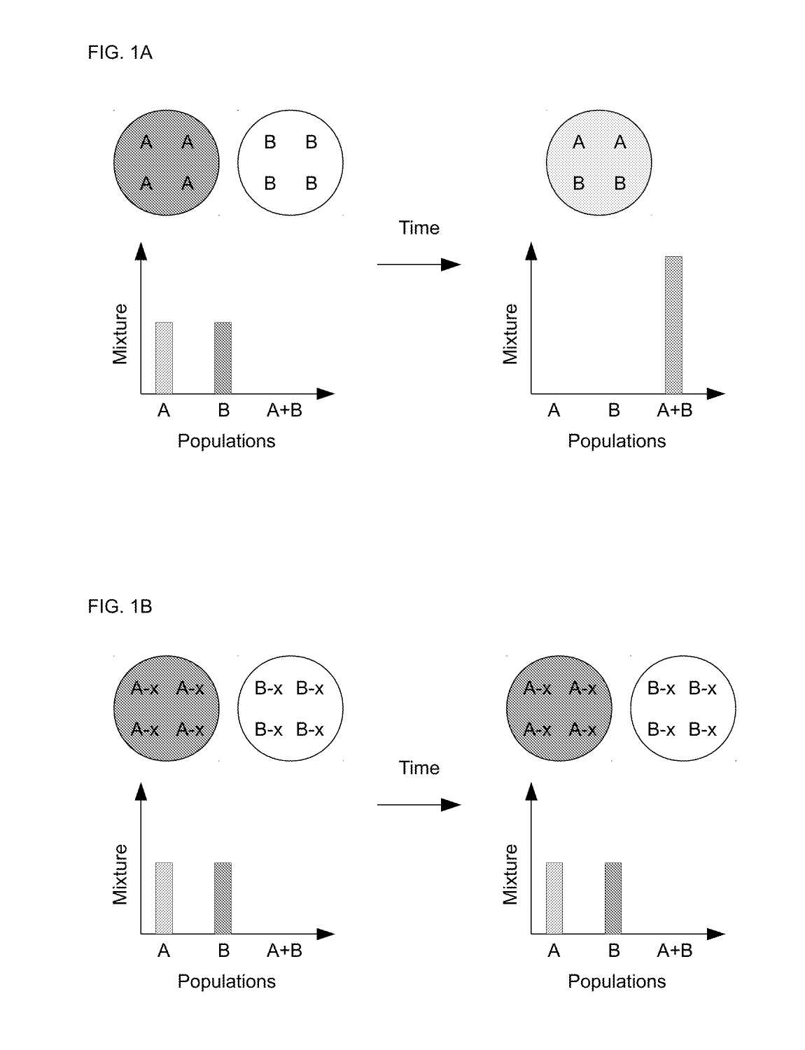

It is assumed that emulsions are stable against coalescence over time; in other words, the droplets do not spontaneously merge. Emulsion stability may be achieved by the addition of any appropriate stabilization factor such as a surfactant added to the continuous phase, or a surfactant added to the dispersed phase or both. For example, one could produce four separate emulsion populations, each containing a different concentration of molecule A. Subsequent mixing of these emulsion populations yields a single, mixed emulsion population comprised of droplets at four different concentrations of molecule A. In general, the concentrations of molecules in all droplets will tend to homogenize to approach thermodynamic equilibrium as shown in FIG. 1A, a phenomena known to one skilled in the art as Ostwald Ripening. Therefore, the problem arises as to how to arrest this approach to equilibrium. The present invention addresses this problem by binding or conjugating transitory molecules to non-transitory ones in order to maintain the heterogeneous distribution of transitory molecule concentrations in emulsion droplets over time, thus enabling a heterogeneous concentration distribution within a population of emulsion droplets to remain stable over time.

One embodiment of the present invention further comprises a method for associating a non-transitory molecule to a target molecule within the emulsion droplet, thereby preventing the targeted molecule from transporting across the interface. In one aspect, the means of associating (or attaching) a non-transitory molecule to a target molecule, may be achieved by a number of means, including but not limited to: chemical binding or conjugation; other forms of chemical bonds, including but not limited to, covalent and hydrogen bonds; biologically mediated attachments such as antibody-antigen binding; and/or DNA binding by Watson-Crick base pairing. In another aspect, other forms of attachment or association may be employed, including but not limited to, encapsulating or enveloping a molecule that is capable of transit across the interface with a larger molecule that will not transit across the interface. One example of this aspect includes embedding the target molecule in a larger polymer shell enclosed within a protein complex. In yet another aspect, one or more molecules may be maintained within a droplet and substantially prevented from transiting the interface by binding with other molecules with preferred solubility in the dispersed phase or, alternatively, with very low affinity for the dispersed phase side of surfactants.

Examples of applications of the methods of the present invention include but are not limited to, the use of stabilized emulsion droplets to create or store a library of biological and/or chemical molecules, with each droplet containing only one type of biological and/or chemical molecule, and where it is desirable for the different types of molecules to not mix or interact with each other. An example of a type of molecule to be stored in the library are fluorescent dyes which by themselves are small in size and may have size and charge properties that allow them to transit across the interface. Possible explanations for the mechanism of transit include being of small enough size that the surfactant on the surface of the interface will bud off into micelles naturally due to entropy, and can surround a small molecule dye and via micelle transport the small molecule dye from one droplet to another. Attaching or conjugating this small molecule dye to a larger molecule such as a protein like BSA (bovine serum albumin) or a large protein dye will create a molecule that may be too large or contain the wrong properties to allow it to transit across the droplet boundary whether via micelle transport or other means.

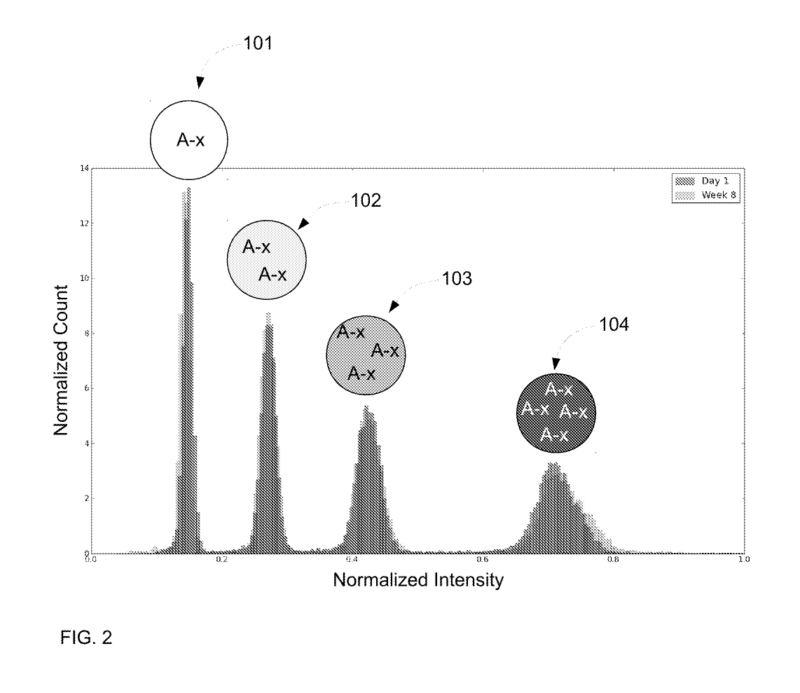

FIG. 2 demonstrates that over time there is little difference (also taking into account experimental error) in the intensity and count/number of droplets from day one to week eight, ultimately allowing for the conclusion that the addition of the x molecule to molecule A stabilizes the heterogeneous concentration distribution of molecule A within the population of droplets. FIG. 2 also includes an illustration of a fluorescent intensity histogram from a mixed emulsion comprised of droplets emulsified separately at four different transitory fluorescent molecule concentrations at two different times. The blue bars in FIG. 2 show the mixed emulsion on the day of mixing and the green bars indicate the same histograms eight weeks later indicating the stability over time of the heterogeneous concentration distribution in this population of droplets.

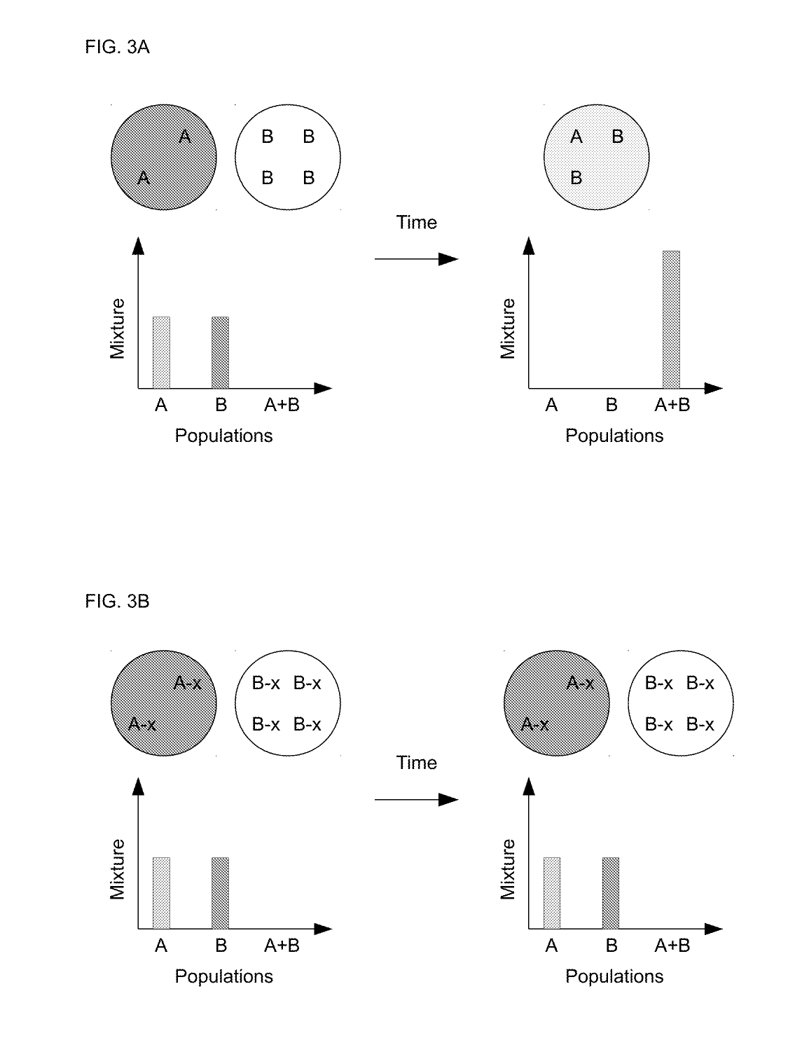

FIG. 3A illustrates an emulsion with two populations of droplets, one containing a small concentration of molecule A and the other containing a higher concentration of molecule B, respectively. As time lapses, the different molecules want to reach an equilibrium, causing the molecules within the droplets to transition over the interface into other droplets, creating a population of droplets with a mix of molecules A and B. This phenomenon causes inaccurate data reads and analysis.

FIG. 3B illustrates a similar situation as is depicted in FIG. 3A, except in FIG. 3B non-transitory molecules (x) have been incorporated to target molecules A and B. Because the non-transitory molecules have been incorporated, molecules A and B (now A-x and B-x, respectively) are no longer able to transpose across the interface, maintaining the both the original concentrations of molecules A and B, but also maintaining the speciation of droplets within an emulsion.

For certain applications it is beneficial to prepare a number of emulsions, each one containing droplets of a single type with a given set of concentrations of transitory molecules and then mix those emulsions in various ratios to produce other emulsions each containing droplets at many different transitory molecule concentrations. In this manner, emulsions can be prepared which contain a library of droplets distinguishable by their transitory molecule concentration.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for maintaining heterogeneous concentrations of molecules within one or more droplet(s) contained within an emulsion (“emulsion droplet(s)”), comprising: one or more emulsion droplets, each comprising at least one target molecule and at least one non-transitory molecule,
wherein the target molecule and non-transitory molecule are associated with each other within a droplet, and wherein the target molecule is maintained within the droplet.

2. A method according to claim 2, wherein the emulsion droplets further comprise one or more population(s) of droplets.

3. A method according to claim 2, wherein the one or more population(s) of droplets are of substantially different sizes (polydispersed population).

4. A method according to claim 2, wherein the one or more population(s) of droplets are of relatively the same size (monodispersed population).

5. A method according to claim 1, wherein the target molecule is selected from: chemical dyes, fluorescent molecules, luminescent molecules, vitamins, pharmaceutical precursors, small molecule pharmaceutical compounds, quantum dots, antigens, sugars, small nucleic acids, nucleosides, and nucleotides.

6. A method according to claim 1, wherein the non-transitory molecule is a non-fluorescently labelled molecule.

7. A method according to claim 6, wherein the non-fluorescently labeled molecule is a protein.

8. A method according to claim 7, wherein the protein is bovine serum albumin (BSA).

9. A method according to claim 1, wherein the non-transitory molecule is a fluorescently labelled molecule.

10. A method according to claim 2, wherein the heterogeneous concentrations of one or more target molecule(s) within a population of droplets is relatively constant over time.

11. A method according to claim 2, wherein the concentration of the one or more target molecule(s) is substantially different between two or more droplets within a population of droplets.

12. A method according to claim 2, wherein the identity of the target molecule is substantially different between two or more droplets within a population of droplets.

13. A method according to claim 1, wherein the method is performed within a microfluidic device.
